(19) United States
(12) Patent Application Publication
(10) Pub. No.: US 2012/0163337 A1
(43) Pub. Date: Jun. 28, 2012

(54) METHOD OF ALLOCATING HOME NETWORK PREFIX, INTER-HANDOFF METHOD, AND MULTI-HOMING SYSTEM THEREOF

(75) Inventors: Yong-Geun Hong, Daejeon (KR); Hyoung Jun Kim, Daejeon (KR); Joo-Sang Youn, Busan (KR)

(73) Assignee: Electronics and Telecommunications Research Institute, Daejeon (KR)

(21) Appl. No.: 13/169,239

(22) Filed: Jun. 27, 2011

(30) Foreign Application Priority Data
Dec. 23, 2010 (KR) 10-2010-0133662

(51) Int. Cl. H04W 36/00; H04W 4/00

(52) U.S. Cl. 370/331

(57) ABSTRACT

Disclosed is a method of allocating a home network prefix to a mobile terminal having multi interfaces by a local mobility anchor. The local mobility anchor allocates a first home network prefix independently to each of the multiple interfaces for simultaneous access of the multi interfaces. The local mobility anchor allocates a single second home network prefix in common to each of the multi interfaces for inter hand-off between the multiple interfaces. In this manner, a home network prefix for simultaneous access of multi interfaces is separated from a home network prefix for inter hand-off.

### CROSS-REFERENCE TO RELATED APPLICATION

This application claims priority to and the benefit of Korean Patent Application No. 10-2010-0133662 filed in the Korean Intellectual Property Office on Dec. 23, 2010, the entire contents of which are incorporated herein by reference.

### BACKGROUND OF THE INVENTION

(a) Field of the Invention

The present invention relates to a method of allocating a home network prefix, an inter-handoff method, and a multi-homing system thereof.

(b) Description of the Related Art

With the recent development of various wireless access technologies and rapid advancement in the performance of terminals such as mobile phones, laptops, and PDAs, there has been an increasing demand for services through a plurality of network interfaces by accessing a variety of wired or wireless networks regardless of time and place.

In particular, as services simply for voice communication have been developed into services for various data communications including Internet access, Internet Engineering Task Force (IETF) has conducted research into many mobility support schemes so that IP addresses, required for internet access, are allocated to terminals and the IP addresses being allocated can be used while moving.

According to mobile IPv6, developed by IETF, a mobile terminal and a home agent (HA) cooperate with each other so as to support the mobility of the mobile terminal.

However, there are a lot of problems in introducing mobile IPv6, which requires modifications to all the terminals in order to support mobility, to networks. Therefore, Proxy Mobile IPv6 has been developed in order to support mobility without any modifications to mobile terminals and applied to actual 3G networks.

PMIPv6 is a network-based mobility support protocol that supports mobility to an IPv6 node without alterations to mobile terminals. A network model, which was assumed at the time of development of PMIPv6, was developed on the assumption of a mobile terminal based on a single network interface. Here, multi interfaces were not taken into consideration.

It is described that a PMIPv6 protocol, specified in RFC 5213, supports multi-homing. In order that a basic PMIPv6 protocol supports multi-homing, the following function is carried out.

That is, PMIPv6 allows for an access to a PMIPv6 domain through multi interfaces for simultaneous access of terminals. In order to allow for simultaneous access, PMIPv6 generates mobility sessions according to interfaces, and a PMIPv6 protocol itself processes a plurality of mobility sessions.

In addition, PMIPv6 allows for inter-handoff between interfaces. For inter hand-off, a mobile access gateway (MAG) sets a value of a handoff indicator flag to “2” when transmitting a proxy binding update (PBU) message to a local mobility anchor (LMA). Then, the LMA, having received this message, allocates a home network prefix (HNP), allocated to a first interface, to a second interface subjected to inter hand-off.

On the basis of the above-described function, the PMIPv6 protocol allows the IPv6 mobility node to gain access to a PMIPv6 domain through multi interfaces at the same time. The core function related thereto is as follows.

That is, when mobility nodes are connected to the PMIPv6 domain through multi interfaces at the same time, the LMA generates and allocates multiple mobility sessions according to the individual interfaces being connected thereto. Each of the mobility sessions is managed by its own lifetime and binding cache entry being separated.

The LMA allocates at least one HNP to each of the interfaces of the mobility node. However, the entirety of HNPs being allocated is managed as part of a single mobility session.

The LMA has a scenario in order to support inter hand-off between two different interfaces of the mobility node. According to this scenario, all the HNPs related to a single interface maintaining a single mobility session need to be associated with another interface during the process of inter hand-off.

Therefore, by a handoff indicator within a PBU message, a new mobile session is generated according to an interface, which is newly activated after inter hand-off, and a time to renew an existing mobility session is determined. Also, this is also carried out by binding cache entry lookup.

However, in terms of the above-described PMIPv6, since multi-homing has basically been developed on the assumption of a single interface, there are various technical difficulties in supporting multi-homing of a mobility node based on multi interfaces.

First, according to PMIPv6, developed by IETF (Internet Engineering Task Force), the LMA is supposed to allocate HNPs belonging only to a mobile terminal and interfaces of the mobile terminal. Due to this characteristic, HNPs become one of the most important bases to distinguish different mobile terminals and different interfaces from each other. In addition, PMIPv6 specifications do not support different mobile terminals and interfaces of the mobile terminals sharing the same HNP.

Moreover, during the inter hand-off process, the LMA allocates all the HNPs, allocated to the first interface before inter hand-off, to the second interface after inter hand-off. Since binding cache entry is also updated, binding information, allocated to the first interface, also disappears from the first interface, and entire binding information, originally allocated to the second interface, also disappears.

However, before inter hand-off, since HNPs are independently allocated according to interfaces, simultaneous access is possible. Since a single mobility session exists after inter hand-off is carried out, simultaneous access becomes impossible.

Moreover, in order to carry out inter hand-off between interfaces, MAG to be used after hand-off appropriately needs to determine a value of a hand-off indicator flag and loads the value onto a PBU message to send it to the LMA.

At this time, in order that the MAG determines a value of the hand-off indicator flag to “2,” it needs to be determined that the mobility node of an interface being connected has multi interfaces and inter hand-off is based on different interfaces.

However, since the MAG does not have any information enough to determine this, there is a high possibility that an error could occur when determining the value of the hand-off indicator flag.

In addition, during the inter hand-off process, since all the HNPs, allocated to the first interface before inter hand-off, are allocated to the second interface, all the data flow through the first interface is forcibly switched to the second interface.

However, even though inter hand-off occurs, some scenarios do not want the entire data flow to be switched but may still want to receive part of the data flows through the first interface.

In addition, all the HNPs, originally allocated to the second interface, disappear, and the second interface after inter hand-off is filled with HNPs, allocated to the first interface. Therefore, the data flow through the HNPs, originally allocated to the second interface, cannot be provided any longer.

In conclusion, simultaneous access of mobile terminals and inter hand-off can be independently supported by a multi-homing support scheme, proposed in PMIPv6 according to the related art, but simultaneous access of mobile terminals and inter hand-off cannot be supported at the same time. In addition, since information enough to inform inter hand-off is not provided, efficient multi-homing support for mobile terminals having multi interfaces cannot be expected.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method of allocating a home network prefix, an inter hand-off method, and a multi-homing system thereof having advantages of allowing for simultaneous access during inter hand-off between interfaces to thereby efficiently support multi-homing.

According to an embodiment of the present invention, there is provided a method of allocating a home network prefix. A method of allocating a home network prefix to a mobile terminal having multi interfaces by a local mobility anchor may include: allocating a first home network prefix independently to each of the multi interfaces for simultaneous access of the multi interfaces; and allocating a single second home network prefix in common to the multi interfaces for inter hand-off between the multi interfaces.

According to another embodiment of the present invention, there is provided an inter hand-off method. An inter hand-off method may include: transmitting, by a mobile access gateway, a first home network prefix for simultaneous access of multi interfaces, allocated by a local mobility anchor, to a first interface of a mobile terminal having the multi interfaces; transmitting a second home network prefix for inter hand-off between the multi interfaces, allocated by the local mobility anchor, to the first interface; and performing inter hand-off on the first interface by using the second home network prefix.

According to yet another embodiment of the present invention, there is a multi-homing system. A multi-homing system for allocating a home network prefix to a mobile terminal having multi interfaces may include: a local mobility anchor allocating a first home network prefix independently to each of the multi interfaces for simultaneous access of the multi interfaces and allocating a single second home network prefix in common to the multi interfaces for inter hand-off between the multi interfaces; and a mobile access gateway connected to each interface of the mobile terminal and transmitting the first home network prefix and the second home network prefix to each interface connected thereto.

### BRIEF DESCRIPTION OF THE DRAWINGS

FIG. 1 is a view illustrating a home network prefix according to an exemplary embodiment of the present invention.

FIG. 2 is a schematic diagram illustrating a multi-homing system according to another exemplary embodiment of the present invention.

FIG. 3 is a flowchart illustrating a method of allocating a home prefix according to yet another exemplary embodiment of the present invention.

FIG. 4 is a view illustrating an inter hand-off process according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, a mobile terminal (MT) may refer to user equipment (UE), a terminal, a mobile station (MS), a subscriber station (SS), a portable subscriber station (PSS), or an access terminal (AT) or include part or whole of functions of the terminal, MT, MS, SS, PSS, and AT.

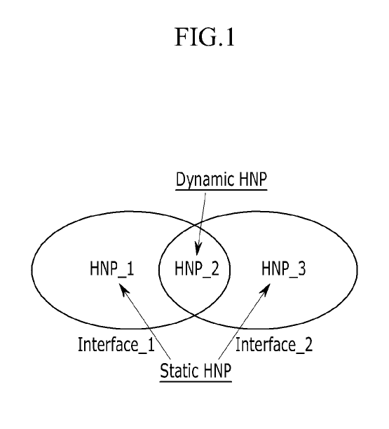

FIG. 1 is a view illustrating a home network prefix according to an exemplary embodiment of the present invention.

Referring to FIG. 1, a home network prefix (HNP) is divided into a static home network prefix (static HNP) and a dynamic home network prefix (dynamic HNP).

At this time, a static home network prefix is a first home network prefix for simultaneous access of multi interfaces of a mobile terminal and is allocated independently to each of the multi interfaces. That is, HNP_1 is allocated to an interface1 (Interface_1) of the mobile terminal, and HNP_3 is allocated to an interface2 (Interface_2).

Such a static home network prefix is used for simultaneous access of multi interfaces. Once the static home network prefix is allocated to one interface, it cannot be moved to another interface.

In addition, a dynamic home network prefix is a second home network prefix for inter hand-off between interfaces and is allocated in common to multi interfaces. That is, the HNP_2 is allocated in common to the interface 1 (Interface_1) and the interface 2 (Interface_2) of the mobile terminal. Such a dynamic home network prefix is used for inter hand-off and may be used for various interfaces and moved between interfaces. However, it can be used for only one interface at one moment.

In this manner, as an HNP is divided into an HNP for inter hand-off and HNP for simultaneous access of multi interfaces, the condition that an HNP, allocated to an interface, should be the only one is satisfied, and at the same time, simultaneous access for the multi interfaces of the mobile terminal is allowed during inter hand-off.

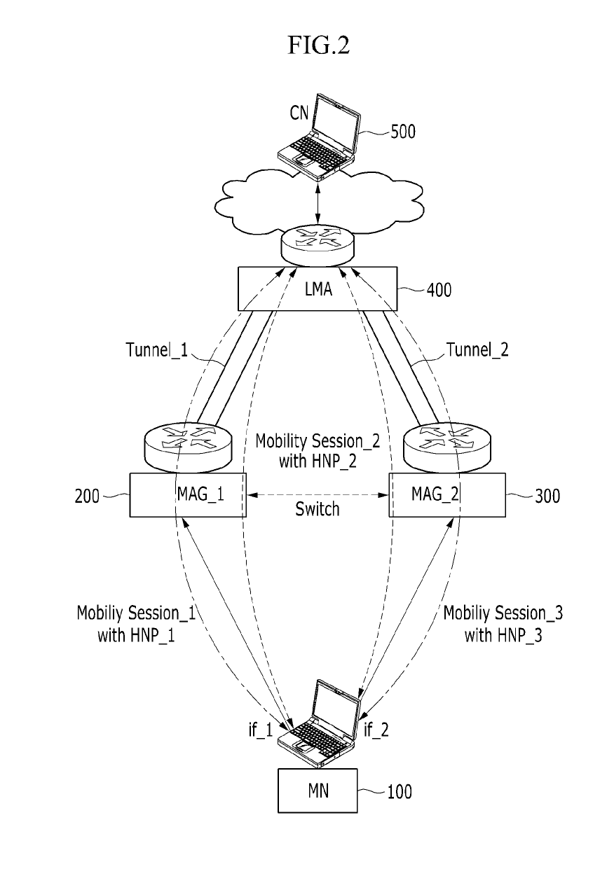

FIG. 2 is a schematic diagram illustrating a multi-homing system according to an exemplary embodiment of the present invention. Referring to FIG. 2, a multi-homing system includes a mobile terminal (Mobile Node) 100, mobile access gateways (hereinafter, referred to as “MAG”) 200 and 300, a local mobility anchor (hereinafter, referred to as “LMA”) 400, and a correspondent node (CN) 500.

Here, the mobile terminal 100 is a terminal that has multi interfaces. For example, the mobile terminal 100 has two different two interfaces. The mobile terminal 100 may be a mobility node that is provided with at least two network interface devices in a PMIP domain where a plurality of heterogeneous networks are mixed.

The MAGs 200 and 300 include a MAG_1 200 and a MAG_2 300 that access interfaces of the mobile terminal 100, that is, an interface1 (Interface_1) and access and an interface2 (Interface_2, 300), respectively.

The MAGs 200 and 300 monitor the mobility of the mobility node in an access link and transmit a signaling message related to mobility in an LMA instead of the mobility node.

A local mobility anchor (hereinafter, referred to as “LMA”) 400 serves as a home agent (HA) for the mobility node in the PMIPv6 domain. The LMA 400 provides a registration process to provide mobility to the mobile terminal and tunneling of data. This LMA is an anchor point in the topology of the home network prefix that is allocated to the mobility node.

The correspondent node (CN) 500 transmits a data packet to the LMA 400.

Here, the mobile terminal 100 generates a mobility session 1 by using the HNP_1. At this time, the interface 1 (Interface_1) is used. A tunnel 1 is generated for the mobility session 1 between the MAG_1 200 and the LMA 400.

In addition, the mobile terminal 100 generates a mobility session 3 by using the HNP_3. At this time, the interface 2 (Interface_2) is used. A tunnel 2 is generated for the mobility session 3 between the MAG_2 300 and the LMA 400.

In addition, the mobile terminal 100 generates a mobility session 2 by using the HNP_2.

Here, the HNP_1 is a static HNP and is used only for the first interface if_1, and the HNP_3 is also a static HNP and is used only for the second interface if_2.

On the other hand, the HNP_2 is a dynamic HNP and can be used both for the first interface if_1 and the second interface if_2. However, first, it is assumed that the HNP_2 is used only for the first interface if_1.

Here, since the LMA 400 has allocated the HNP_2 both to the first interface if_1 and the second interface if_2, if the MAG_2 300 senses hand-off from a lower layer during inter hand-off, the MAG_2 300 checks relevant information of the mobile terminal 100, that is, a routing table. Here, if the HNP_2 related to the mobile terminal 100 exists in the routing table of the MAG_2 300, the MAG_2 300 can recognize that inter hand-off occurs.

Therefore, a value of a hand-off Indicator is set to “2” and a PBU (Proxy Binding Update) message is sent to the LMA 400. In this manner, the division information of HNPs according to an exemplary embodiment of the present invention may be sufficient for the MAGs 200 and 300 to determine the value of the hand-off indicator.

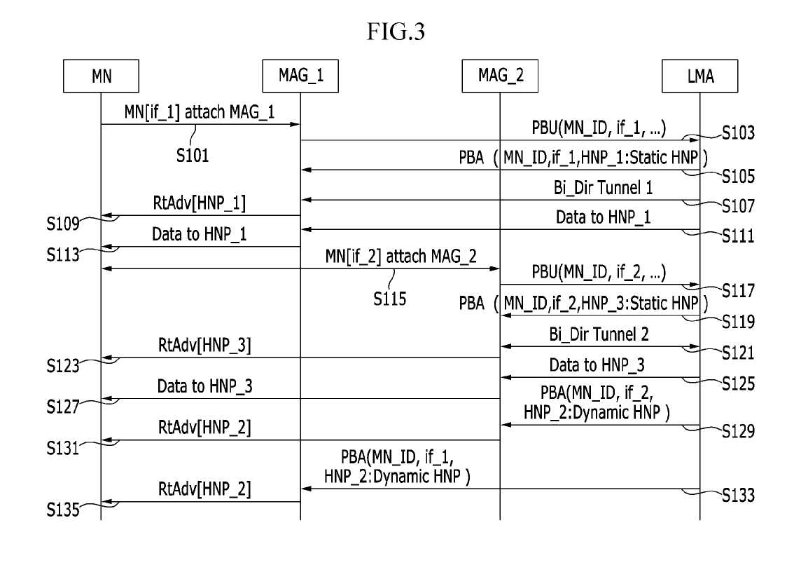

FIG. 3 is a flowchart illustrating a method of allocating a home prefix according to another exemplary embodiment of the present invention.

Referring to FIG. 3, the mobile terminal (MN in FIG. 2) 100 accesses the MAG_1 200 by using the first interface if_1 in operation S101. That is, the mobile terminal 100 is connected to the PMIPv6 domain through the MAG_1 200.

The MAG_1 200 transmits a PBU message to the LMA 400 according to PMIPv6 specifications so as to be connected to the PMIPv6 domain in operation S103. Then, the MAG_1 200 receives a PBA (Proxy Binding Acknowledgement) message in operation S105. Here, the PBA message includes the HNP_1 that the LMA 400 allocates to the first interface if_1.

A bi-directional tunnel 1 (Bi-Dir Tunnel1) is then generated between the MAG_1 200 and the LMA 400 in operation S107.

After the bi-directional tunnel 1 (Bi-Dir Tunnel1) is generated, the MAG_1 200 sends a router advertisement (RtAdv) message to the first interface if_1 of the mobile terminal 100 in operation S109 to inform the HNP_1 allocated to the first interface if_1.

Then, the LMA 400 transmits data to the MAG_1 200 by using the HNP_1 in operation S111, and the MAG_1 200 also transmits data to the mobile terminal 100 by using the HNP_1 in operation S113.

Meanwhile, the mobile terminal 100 is connected to the PMIPv6 domain via the MAG_2 300 by using the second interface if_2 in operation S115. Then, the MAG_2 300 transmits the PBU message to the LMA 400 in operation S117 and receives a PBA message including HNP_3 allocated to the second interface if_2 in operation S119. A bi-directional tunnel 2 (Bi-Dir Tunnel2) is generated between the MAG_2 300 and the LMA 400 in operation S121.

In this manner, after the bi-directional tunnel 2 (Bi-Dir Tunnel2) is generated in operation S121, the MAG_2 300 sends an RtAdv message, which includes the HNP_3 allocated to the second interface if_2, to the second interface if_2 of the mobile terminal 100 in operation S123. Then, the LMA 400 transmits data to the MAG_2 300 by using the HNP_3 in operation S125, and the MAG_2 300 also transmits data to the mobile terminal 100 by using the HNP_3 in operation S127.

When the second interface if_2 of the mobile terminal 100 is connected to the PMIPv6 domain, the LMA 400 recognizes that the mobile terminal 100 is a terminal having multi interfaces and prepares to send a dynamic HNP(HNP_2), which is the second home network prefix, to the multi interfaces of the mobile terminal 100.

That is, the LMA 400 transmits two PBA messages to the MAG_1 200 and the MAG_2 300, respectively, in order to allocate the HNP_2 to both the first interface if_1 and the second interface if_2 in operations S129 and S133.

Then, the MAG_1 200 and the MAG_2 300 transmit RtAdv messages including the HNP_2 to the first interface if_1 and the second interface if_2, respectively, in operations S131 and S135.

Here, even though the HNP_2 is allocated to both the first interface if_1 and the second interface if_2, it is assumed that it is effective only for the first interface if_1 through a separate flag and the second interface if_2 has actual information about the HNP_2 but does not use it.

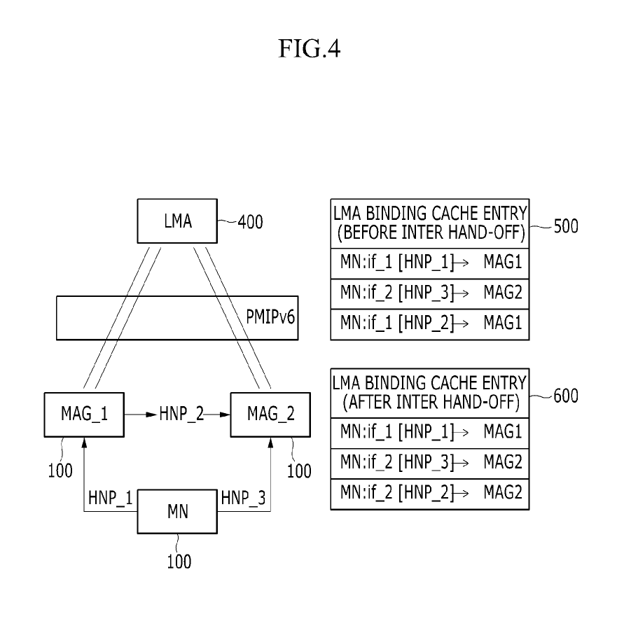

FIG. 4 is a view illustrating an inter hand-off process according to another exemplary embodiment of the present invention.

Referring to FIG. 4, the HNP_1 is allocated to the first interface if_1 of the mobile terminal (MN) 100 through the MAG_1 200 with reference to LMA binding cash entry 600 before inter hand-off. The second interface if_2 receives the HNP_3 through the MAG_2 300. The HNP_2 is allocated to the first interface if_1 and the second interface if_2 through the MAG_1 200 and the MAG_2 300, respectively. Here, even though the HNP_2 is allocated to the second interface if_2 through the MAG_2 300, it is set so that the second interface if_2 has information about the HNP_2 and the HNP_2 is not effective herein.

Therefore, the first interface if_1 and the second interface if_2 of the mobile terminal 100 can be simultaneously connected to the PMIPv6 domain through the HNP_1 and the HNP_3, respectively.

Then, with reference to the LMA binding cash entry 600 after inter hand-off, no change is made to the allocation of the HNP_1 and the HNP_3 inter hand-off but the allocation of the HNP_2 changes when inter hand-off occurs.

That is, before inter hand-off occurs, the HNP_2 is allocated to the first interface if_1 of the mobile terminal 100 via the MAG_1 200. On the other hand, when inter hand-off occurs, the HNP_2 is allocated to the second interface if_2 of the mobile terminal 100 via the MAG_2 300. Then, inter hand-off conforming to general PMIPv6 specifications is carried out.

Here, since inter hand-off is performed using the HNP_2, simultaneous access is still available using the HNP_1 and the HNP_3.

According to an exemplary embodiment of the present invention, Proxy Mobile IPv6, which is a network-based mobility support protocol, allows for simultaneous access of multi interfaces during inter hand-off to thereby support multi-homing in the true sense.

In addition, MAG being moved during inter hand-off can easily determine a hand-off Indicator.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of allocating a home network prefix to a mobile terminal having multi interfaces by a local mobility anchor, the method comprising:
allocating a first home network prefix independently to each of the multi interfaces for simultaneous access of the multi interfaces; and
allocating a single second home network prefix in common to the multi interfaces for inter hand-off between the multi interfaces.

2. The method of claim 1, wherein the first home network prefix is a static home network prefix, and
the second home network prefix is a dynamic home network prefix.

3. The method of claim 1, wherein the allocating of the single second home network prefix in common comprises transmitting information indicating whether the second home network prefix is effective or not when the second home network prefix is allocated so that the second home network prefix is used for a predetermined interface.

4. The method of claim 3, wherein the information indicating whether the second home network prefix is effective or not is contained in a predetermined flag previously defined in a message allocating the second home network prefix and being sent to a mobile access gateway connected to the predetermined interface.

5. The method of claim 3, wherein a request for the inter hand-off using the second home network prefix is received from the predetermined interface after the allocating of the single second home network prefix in common.

6. The method of claim 1, further comprising
determining whether at least two interfaces of the mobile terminal are respectively connected by using each first home network prefix,
wherein the allocating of the single second home network prefix in common comprises allocating the second home network prefix in common to the multi interfaces of the mobile terminal when the at least two interfaces are connected.

7. An inter hand-off method comprising:
transmitting, by a mobile access gateway, a first home network prefix for simultaneous access of multi interfaces, allocated by a local mobility anchor, to a first interface of a mobile terminal having the multi interfaces;
transmitting a second home network prefix for inter hand-off between the multi interfaces, allocated by the local mobility anchor, to the first interface; and
performing inter hand-off on the first interface by using the second home network prefix.

8. The inter hand-off method of claim 7, wherein the performing of the inter hand-off comprises:
sensing a hand-off state of the first interface;
checking whether the second home network prefix is allocated to the first interface with reference to a routing table; and
determining that a request for the inter hand-off is made when the second home network prefix is allocated thereto, and transmitting the request for the inter hand-off to the local mobility anchor.

9. A multi-homing system for allocating a home network prefix to a mobile terminal having multi interfaces, the multi-homing system comprising:
a local mobility anchor allocating a first home network prefix independently to each of the multi interfaces for simultaneous access of the multi interfaces and allocating a single second home network prefix in common to the multi interfaces for inter hand-off between the multi interfaces; and
a mobile access gateway connected to each interface of the mobile terminal and transmitting the first home network prefix and the second home network prefix to each interface connected thereto.

10. The multi-homing system of claim 9, wherein the mobile access gateway determines the inter hand-off when it is determined that the second home network prefix is allocated with reference to a routing table with respect to the mobile terminal if a hand-off state of a predetermined interface among the multi interfaces of the mobile terminal is sensed.

11. The multi-homing system of claim 10, wherein the mobile access gateway performs the inter hand-off by using the second home network prefix through the mobile access gateway connected to interfaces subjected to inter hand-off.

12. The multi-homing system of claim 9, wherein the local mobility anchor transmits information indicating whether the second home network prefix is effective or not when the second home network prefix is allocated so that the second home network prefix can be used for a predetermined interface.

13. The multi-homing system of claim 12, wherein the information indicating whether the second home network prefix is effective or not is contained in a predetermined flag previously defined in a message allocating the second home network prefix and being sent to the mobile access gateway connected to the predetermined interface.

14. The multi-homing system of claim 12, wherein the local mobile anchor determines by using the first home network prefix whether at least two interfaces of the mobile terminal are connected and allocates the second home network prefix in common to the multi interfaces of the mobile terminal when the at least two multi interfaces are connected.
